(19) United States
(12) Patent Application Publication
(10) Pub. No.: US 2005/0262490 A1
(43) Pub. Date: Nov. 24, 2005

(54) Method of introducing digital signature into software

(75) Inventors: Clark David Thomborson, Auckland (NZ); Jasvir Singh Nagra, Auckland (NZ)

Correspondence Address: NIXON & VANDERHYE, PC, 901 NORTH GLEBE ROAD, 11TH FLOOR, ARLINGTON, VA, 22203, US

(73) Assignee: Auckland Uniservices Limited, Auckland (NZ)

(21) Appl. No.: 11/132,389

(22) Filed: May 19, 2005

(30) Foreign Application Priority Data
May 19, 2004 (NZ) 533028

(51) Int. Cl. G06F 9/45

(52) U.S. Cl. 717/145; 717/144

(57) ABSTRACT

The invention provides a method of introducing a digital signature into a software program, the software having a plurality of basic blocks, the method comprising the steps of: executing the software program; recording the sequence(s) of basic blocks executed within the software program; modifying the software program to increase the number of threads, thereby increasing the number of possible sequences of basic blocks executed within the software program; and associating the sequence of basic blocks executed by one or more threads with a digital signature. The invention also provides a related method of extracting a digital signature from a software program, related systems, and related computer programs stored on tangible storage media.

### FIELD OF INVENTION

The invention relates to a method of introducing a digital signature into a software program and a method of extracting a digital signature from a software program. The invention has particular application in software watermarking which is a technique for embedding an identifier into a piece of software in order to encode some identifying information about it.

### BACKGROUND TO INVENTION

Software watermarking enables identifying information to be embedded in a software program. This identifying information can be used to demonstrate ownership. In cases of piracy, software watermarking can make it possible to trace software to the source of its illegal distribution. No single watermarking algorithm has yet emerged from the prior art that is effective against all existing and known attacks. In fact, it is generally agreed that it is not possible to devise a watermark that some sufficiently determined attacker would not be able to defeat. As a result, the goal of the watermarking community is to develop techniques that are sufficiently robust that the resources required to defeat the watermark are too expensive to be worth the attacker's while.

Software watermarks can be used for different purposes and their desirable properties vary depending on their use. For software piracy, the two properties that are of interest are “robustness” and “invisibility”. Robustness ensures that the watermark is difficult for an attacker to remove and therefore the watermark can act as a software intellectual property identifier. Invisibility means that the watermarks are designed to be non-apparent to the end-user and therefore do not interfere with legitimate use of the program.

The earliest software watermarks were static watermarks where the watermark was embedded in either the code section, for example in variable names or order of executable statements, in the static data sections, for example strings, images and headers of a program, or in the I/O interface between the client and the server.

Static watermarks are particularly susceptible to obfuscation attacks. Two such attacks involve breaking and scattering all strings and other static data around the program and/or replacing this static data with code that generates the same data at run time. Both these attacks are extremely effective in making watermark detection impractical.

Dynamic data structure watermarks are an alternative to static watermarks. These watermarks alter the original program so that a data structure that represents the watermark is built whenever the program is run or executed with the correct input. One example for Java programs involves modifying the application byte code to make it build a structure at run time that encodes the watermark. This structure is recognised as the watermark by dumping and analysing the Java heap.

The present invention proposes a new watermarking technique in which a digital signature or watermark is embedded within the threading behaviour of the program.

### SUMMARY OF INVENTION

The term ‘comprising’ as used in this specification and claims means ‘consisting at least in part of’. That is to say, when interpreting statements in this specification and claims that include the term ‘comprising’, the features prefaced by that term in each statement all need to be present, but other features can also be present.

In broad terms in one form the invention provides a method of introducing a digital signature into a software program, the software having a plurality of basic blocks, the method comprising the steps of: executing the software program; recording the sequence(s) of basic blocks executed within the software program; modifying the software program to increase the number of threads, thereby increasing the number of possible sequences of basic blocks executed within the software program; and associating the sequence of basic blocks executed by one or more threads with a digital signature.

In another form in broad terms the invention provides a method of extracting a digital signature from a software program, the software having a plurality of basic blocks and a plurality of threads, and configured to accept data input, the method comprising the steps of: executing the software program with a predefined data input; recording the sequence(s) of basic blocks executed within the software program given the data input; and identifying the digital signature from the recorded sequences of basic blocks executed by one or more threads.

In another form in broad terms the invention provides a system for introducing a digital signature into a software program, the software having a plurality of basic blocks, where the system is configured to: execute the software program; record the sequence(s) of basic blocks executed within the software program; modify the software program to increase the number of threads, thereby increasing the number of possible sequences of basic blocks executed within the software program; and associate the sequence of basic blocks executed by one or more threads with a digital signature.

In another form in broad terms the invention provides a system for extracting a digital signature from a software program, the software having a plurality of basic blocks and a plurality of threads, and configured to accept data input, where the system is configured to: execute the software program with a predefined data input; record the sequence(s) of basic blocks executed within the software program given the data input; and identify the digital signature from the recorded sequences of basic blocks executed by one or more threads.

In another form in broad terms the invention provides a computer program stored on tangible storage media comprising executable instructions for introducing a digital signature into a software program, the software having a plurality of basic blocks, the method comprising the steps of: recording the sequence(s) of basic blocks executed within the software program; modifying the software program to increase the number of threads, thereby increasing the number of possible sequences of basic blocks executed within the software program; and associating the sequence of basic blocks executed by one or more threads with a digital signature.

In another form in broad terms the invention provides a computer program stored on tangible storage media comprising executable instructions for extracting a digital signature from a software program, the software having a plurality of basic blocks and a plurality of threads, and configured to accept data input, the method comprising the steps of: executing the software program with a predefined data input; recording the sequence(s) of basic blocks executed within the software program given the data input; and identifying the digital signature from the recorded sequences of basic blocks executed by one or more threads.

### BRIEF DESCRIPTION OF THE FIGURES

Preferred forms of the watermarking technique of the invention will now be described with reference to the accompanying figures in which:

FIG. 1 is a block diagram of a computer system with watermarking capability.

FIG. 2 illustrates the introduction of unconstrained multiple threads to a simple program;

FIG. 3 illustrates the introduction of constrained multiple threads to the simple program of FIG. 2;

FIG. 4 illustrates a watermarking process in accordance with the invention;

FIG. 5 illustrates a sample watermarked code produced in accordance with the invention;

FIG. 6 illustrates a preferred form implementation of a closure technique in accordance with the invention;

FIG. 7 shows a preferred form embedding process for a bit 0;

FIG. 8 shows a preferred form embedding process for a bit 1;

FIG. 9 illustrates another preferred form implementation of a closure technique in accordance with the invention;

FIG. 10 shows a recognition process in accordance with the invention;

FIG. 11 shows a table of benchmark results;

FIG. 12 shows graphs of performance impact of the invention on-software code; and

FIG. 13 shows a preferred form embedding for a multiple-bit digital signature.

### DETAILED DESCRIPTION OF PREFERRED FORMS

Typical software programs are formed from a plurality of basic blocks of program code. Each basic block includes one or more instructions. A basic block is essentially a piece of straight line code without any jumps or jump targets. When a computer program executes, there will often be a sequence of basic blocks that are executed within the software program. The computer program is executed by an executing process. A thread is one part of an executing process. A sequence of instructions is a record or partial record of what the thread has performed on execution. This sequence of instructions is also referred to as an execution trace. A single thread executes a sequence of instructions. Some computer programs contain multiple threads and are said to be multi-threaded. The execution trace of a multi-threaded program contains multiple sequences of instructions, one for each thread.

In some circumstances, a computer program is configured to accept a data input. The particular data input supplied to the computer program may cause the computer program to follow a different path or thread on execution.

The invention involves a new watermarking technique known as thread-based watermarking in which the basic idea is to embed the watermark in the threading behaviour of the program. In other words, the particular sequence of basic blocks followed by a computer program given a specific data input either represents or is at least associated with a digital signature.

One technique of the invention relies on introducing new threads into single-threaded sections of a program. In an unsynchronised multi-threaded program, two or more threads may try to read or write to the same area of memory or try to use resources simultaneously. This results in a race condition, a situation in which two or more threads or processes are reading or writing some shared data, and the final result depends on the timing of how the threads are scheduled.

One technique that allows threads to share resources in a controlled manner is using a mutual exclusion object or mutex. A mutex has two states, namely locked and unlocked. Before a thread can use a shared resource, it must lock the corresponding mutex. Other threads attempting to lock a locked mutex will block and wait until the original thread unlocks it. Once the mutex is unlocked, the queued threads contend to acquire the lock on the mutex. The thread that wins this contention is decided by priority, order of execution, or by some other algorithm. However, due to the nature of multi-threaded execution and the number of factors that can affect the timing of thread execution, the particular thread that acquires the lock is difficult to predict and appears to be largely random.

In order to embed or introduce a digital signature, known as a watermark, into a software program, advantage is taken of the fact that although thread contention appears to be random, by carefully controlling the locks in a program, a partial ordering can be forced on the order in which some parts of the program are executed. The invention involves modifying the software program to control the sequence or create a modified sequence of basic blocks executed within the software program given a data input.

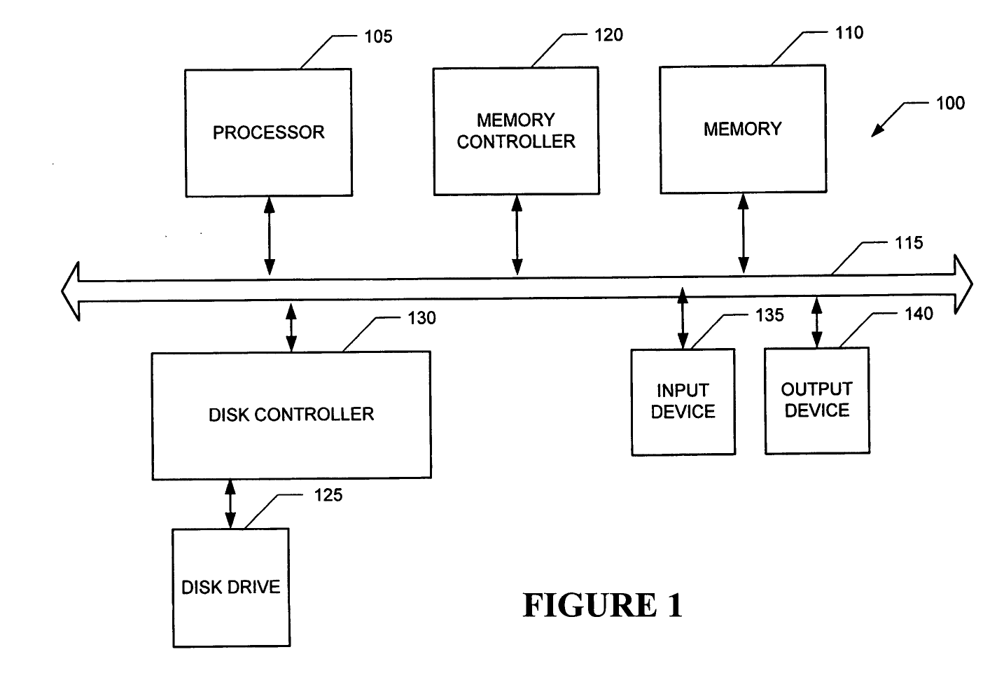

FIG. 1 shows a computer system 100 suitable for implementation of a method of introducing a digital signature into a software program and a method of extracting a digital signature from a software program. The system 100 typically includes a processor 105 that receives data and program instructions from a temporary data storage device, such as a memory device 110, over a communications bus 115. A memory controller 120 governs the flow of data into and out of the memory device 110. The system 100 also includes one or more persistent data storage devices, such as a disk drive 125 that stores data in a manner prescribed by a disk controller 130. One or more input devices 135, such as a mouse and a keyboard, and output devices 140 such as a monitor and a printer, allow the computer system to interact with a human user and with other computers.

The computer programs described below are typically stored on disk drive 125. On execution a memory controller 120 fetches the computer program from the disc drive 125 and stores the program in memory 110.

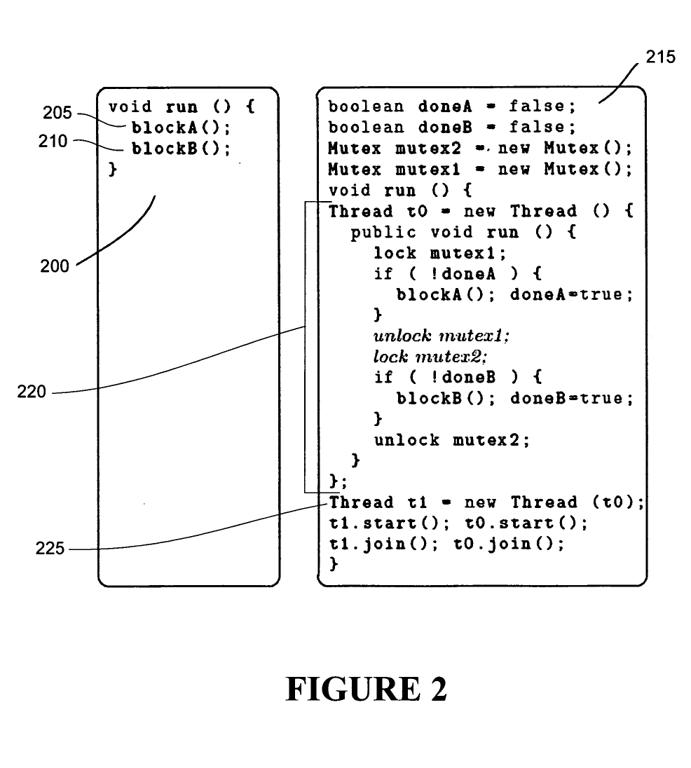

FIG. 2 illustrates at 200 a simple snippet of a program with a run ( ) method that calls other methods BlockA( ) 205 and BlockB( ) 210. BlockA( ) and BlockB( ) represent basic blocks executed within the software program. The original program 200 is modified to control the sequence of basic blocks executed within the software program resulting in modified program 215. New threads are introduced into the program to execute both BlockA( ) and BlockB( ). The modified version of the program as shown at 215 remains correct and semantically equivalent to the original, however there are several paths or threads of execution with either thread t0 220 or thread t1 225 executing BlockA( ) followed by either thread t0 220 or t1 225 executing BlockB( ). In order to embed information within the program, the locks are manipulated so that only a given subset of paths through the software program is taken.

There are four different correct paths through modified program 215. The first occurs when thread t0 executes BlockA( ) then BlockB( ). The second occurs when thread t0 executes BlockA( ) then thread t1 executes BlockB( ). The third occurs when thread t1 executes BlockA( ) then thread t0 executes BlockB( ). The fourth occurs when thread t1 executes BlockA( ) then BlockB( ). Modified program 215 represents a multithreaded but unconstrained version of original program 200.

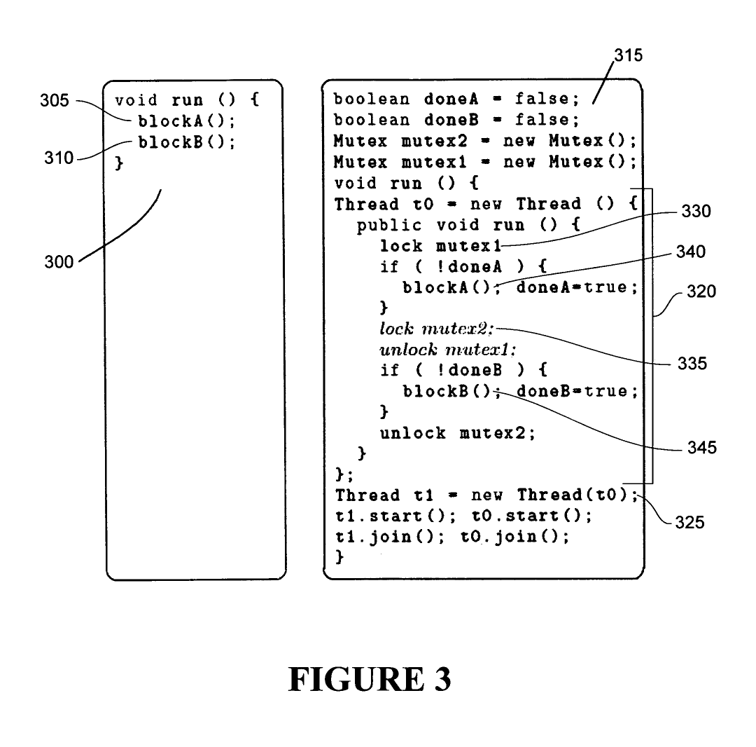

FIG. 3 illustrates at 300 the same simple snippet of a program with a run( ) method that calls methods BlockA 305 and BlockB 310. Once again, BlockA( ) and BlockB( ) represent basic blocks executed within the software program. This time the original program 300 is modified so that the two new threads race to acquire a lock on mutex1 similar to that shown in FIG. 2, however in this case whichever thread 320 or 325 locks 330 this mutex is also guaranteed to lock 335 mutex2 and therefore executes 340 BlockA( ) then executes 345 BlockB( ).

The scenario where the same thread executes BlockA( ) and BlockB( ) can be recognised as distinct from the case where different threads execute BlockA( ) and BlockB( ). The behaviour of the software program in each of these cases can be used to embed part of a digital signature by associating each of the sequences with part of a digital signature, or recognising that the sequences represent part of a digital signature.

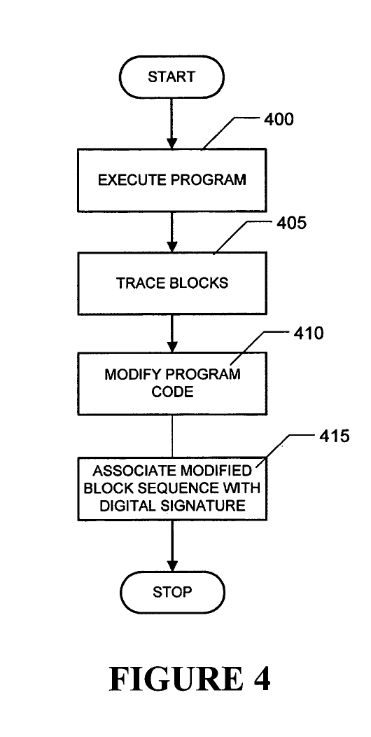

The advantage of allowing some thread contention to remain is that although it allows a bit to be embedded, the actual path of execution still changes every time the program is executed. This makes the attacker's task of determining which exact sequence embeds the mark more difficult. Using the above techniques, it is possible to implement thread-based watermarking for Java byte code. Referring to FIG. 4, the preferred form implementation of the encoding process consists of two stages. In the first stage, known as the tracing phase, the dynamic behaviour of the program is captured by executing 400 the program with a secret input I, and tracing 405 its execution on a secret input, I. The software program is executed with this data input and the sequence of basic blocks executed within the software program given this data input is recorded.

The second stage of the encoding process of the invention is to embed the watermark number W selected by the user into the program code by modifying the behaviour of the program on the secret input I. In this way, the software program is modified 410 to control the sequence of basic blocks executed within the software program given the data input I. When the modified program is executed with input I, the program is traced and the resulting sequence of basic blocks executed represents or is at least associated with 415 the digital signature or watermark.

The encoding process is now described in greater detail.

Encoding Process

Tracing Phase

The tracing phase of the encoding process is commenced by performing control flow analysis on the input program to build up a control flow graph. This graph represents the possible paths or threads through a program. The nodes of the graph represent basic blocks while the directed edges represent jumps from one node to another. As described above, a basic block is a piece of straight line code without any jumps or jump targets.

The software program is instrumented in order to write a program trace to a data file stored in computer memory. The software program is executed using secret input I. The trace T is a series of tuples (tᵢ, bᵢ) where bᵢ is the block ID of every basic block executed and tᵢ is the ID of the thread or sequence that executed bᵢ. It will be appreciated that at least two or more of the basic blocks have associated block identifiers that distinguish the basic blocks from each other. These block identifiers could comprise the addresses or locations of the basic blocks in executable memory.

Thread IDs are selected by the operating system in most computer systems. However, for conciseness and specificity in the description of a preferred form of this invention, it is assumed that thread ID “1” is the ID assigned by the operating system to the thread ID which appears most often in trace T. The sequence of blocks executed by this thread is B₁=<bᵢ:(1,bᵢ)εT>.

Input I is preferably selected such that the sequence B₁ of blocks executed by thread “1” is reproducible on multiple runs or executions of the program with input I, at different times and on different computers. The tuples on the trace are temporally ordered, however temporal ordering can be problematic to determine when the program is executed on a multiprocessor. In a preferred embodiment, the trace is collected when the program is running on a single processor, whenever this is feasible. Even when it is infeasible to run a program on a single processor, a successful watermark may still be embedded by this invention, if a reproducible trace can be obtained by some method.

It is insecure to embed a lengthy watermark in a very short program. Accordingly, in a preferred implementation of this invention, the number of basic blocks is increased, if this is necessary to obtain a sequence B₁ with at least three blocks for each bit in the watermark. The additional blocks must have no discernable effect on the input-output behaviour of the program. A suitable method for adding such a block is to subdivide one or more existing basic block(s) which contain more than one executable statement. Another suitable method is to introduce arbitrary code which resembles code existing elsewhere in the program, but which has no effect on program behaviour. This arbitrary code could consist of several redundant basic blocks, meaning that the basic blocks have no effect on program behaviour.

The program trace serves two purposes. Primarily, the program trace is used to find the basic blocks that are executed by the input program when given the chosen input. These basic blocks are potential blocks to embed bits of the watermark. As a secondary purpose, the program trace counts how often each basic block gets executed and therefore helps identify tight loops, recursion and other program hotspots. There is a computational and thread switching run time cost associated with inserting new threads into the program. In view of this run time cost, it is preferable to avoid inserting watermarks into these hotspots.

The secret input I acts as the key, and the watermark will be expressed when this secret input is entered. Other inputs may express other watermarks. Keeping this input a secret impedes an attacker who gains access to the recogniser from mounting an attack involving creating a non-watermarked program when a watermark recogniser is available.

Embedding Phase

The embedding or modifying phase modifies the program code so that the watermark W can be extracted from a trace of basic blocks executed on the input sequence I.

The digital signature or watermark preferably comprises a bit string, one or more of the bits in the bit string representing a sequence or thread of basic blocks executed. In one preferred form, a 24 bit watermark string W is encoded into a 32 bit string E using a randomly chosen code. The sparseness of this code gives a strong error detection property that can be used to gain confidence in the accuracy of the watermark extraction step, by distinguishing spurious signals from intentional watermarks. If a 32-bit value is generated uniformly at random from the set {0, 1}³², then the probability of this value being a legal codeword is one chance in 256 (=½⁸).

Other coding methods may be employed in the practice of this invention. An appropriate error-detecting or error-correcting code should be selected by someone of ordinary skill in the art of coding theory, after consideration of the relevant design considerations. These considerations include an assessment of the tolerable level of “false positive” and “false negative” errors in watermark detection, and an estimate of the entropy of the thread transition sequence (t₁, t₂, . . . tₙ) in the trace of an unwatermarked program.

The 32-bit encoded watermark string E is embedded in a length-96 subsequence of the blocks B₁ executed by the main thread (with ID=“1”) in trace T. The i-th bit Eᵢ of the watermark is embedded, by the method disclosed below, in blocks B₁[3i], B₁[3i+1] and B₁[3i+2].

In a preferred embodiment, the subsequence is chosen to avoid hotspots because, as described above, thread switching code is expensive in time. Basic blocks that are executed repeatedly are poor candidates for embedding as slowing these basic blocks down will significantly deteriorate the overall performance of the computer program. Furthermore, it is preferred to select some of the basic blocks that are input dependent to make the value of the expressed watermark vary with I.

In order to embed a watermark, it is necessary for a chosen thread to be able to execute an arbitrary piece of code that it is passed. Therefore, it is preferable to extend the Java Thread class so that threads can be passed a closure to execute. A closure is a data structure that contains an expression and an environment of variable bindings in which the expression is to be evaluated.

There is no direct support for closures in Java. However, there are techniques for implementing closures in Java in the prior art. In the present implementation a closure is translated into a class that implements the Runnable interface. This interface contains a single run ( ) method. The body of the closure is inserted into the run ( ) method of the new class while the call location is replaced with an instantiation of the new class and an invocation of the run ( ) method.

A closure enables the introduced threads to access and possibly alter the local variables used by the basic block. Unfortunately, formal parameters in Java are passed by value and a mechanism is required by which to pass updates out of the function body. In the preferred implementation, a Locals class is constructed for every closure in which all variables used by the closure are captured. When the closure is instantiated, this environment is passed to it.

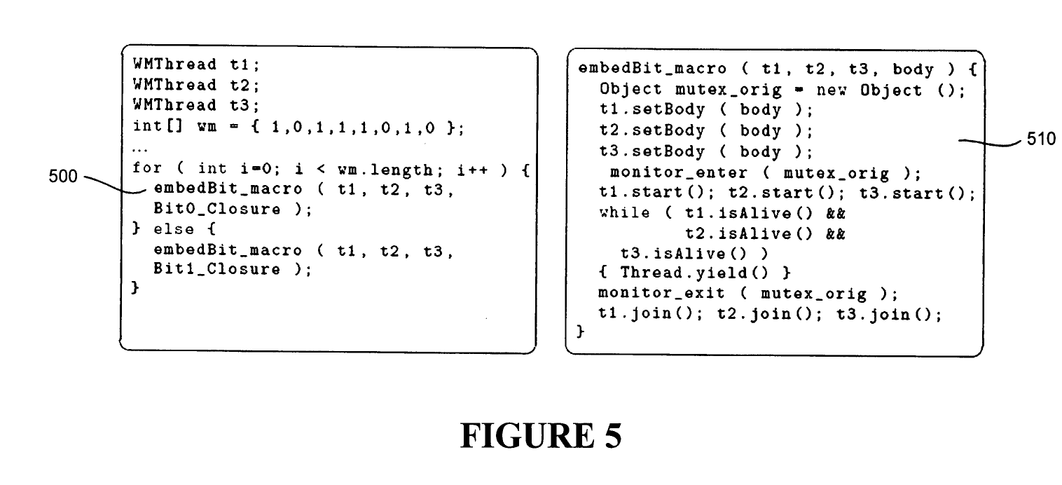

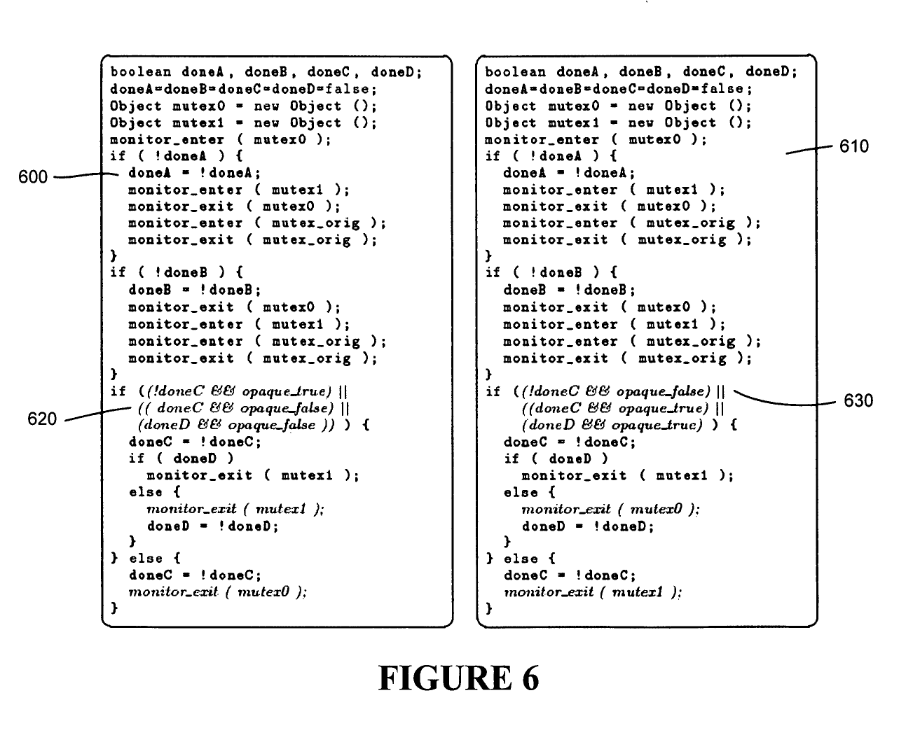

The software program is modified to control the sequence of basic blocks executed within the software program given data input I. More specifically, the invention could insert, into basic blocks B₁[3i], B₁[3i+1] and B₁[3i+2], code that causes the threads to switch in such a way as to encode the i-th bit Eᵢ of the watermark. A simple implementation, for the case of an 8-bit watermark signal E, is described with reference to FIGS. 5 and 6.

In a preferred implementation, bit 0 is encoded as a sequence of three basic blocks executed by three different threads. A bit 1 is encoded as a sequence of three basic blocks, where the first and third basic blocks are executed by the same thread and the second basic block is executed by a different thread. In this way, the value 1 in the digital bit signature is associated with one controlled sequence of basic blocks in which the first and third basic blocks are executed by one thread and the second basic block is executed by another thread. The value 0 on the other hand is associated with a controlled sequence in which three basic blocks are each executed by three different threads. The advantage of such an encoding scheme over one that explicitly uses named blocks and threads is that it is more resilient to renaming attacks.

Java monitors are ideally used to control the ordering of locks. The only mechanism in the Java language for manipulating monitors is the synchronised keyword that acquires a lock on an object before executing a block or method. The lock is released upon exit from the synchronised block or method. The locks in all synchronised blocks and methods must be fully nested and this is not sufficiently expressive for the purposes of the invention.

It is preferable to use the monitor_enter and monitor_exit instructions in Java bytecode. These have the advantage that they cannot be decompiled to synchronised methods or blocks in Java source code. This provides some defence against decompilation attacks.

FIG. 5 illustrates at 500 the code inserted to embed the bits 10111010. The embed_bit_macro call is a macro that expands as shown at 510. The setBody method takes a closure as its argument. The monitor_enter( ) and monitor_exit( ) constructs in FIG. 5 are, in a preferred embodiment, transformed into the corresponding instructions in Java bytecode by the following process. First, the constructs are macro-expanded into a Java source code statement using a distinctive variable name. After compilation, the bytecode is examined to find the resulting, easily distinguished, bytecode sequences, which are then replaced with the desired bytecode instructions for monitor_enter and monitor_exit.

FIG. 6 illustrates an implementation of Bit0_Closure at 600 and Bit1_Closure at 610. The differences between the implementation in 600 and 610 are highlighted in italics at 620 and 630 respectively.

One problem with the simple implementation shown in FIGS. 5 and 6 is that the inserted threads do not in fact perform any computation. Such threads are conspicuous and easily removed. In order to tamper-proof the watermark, it is desirable to use the new threads to perform the computation that was originally occurring in the basic block.

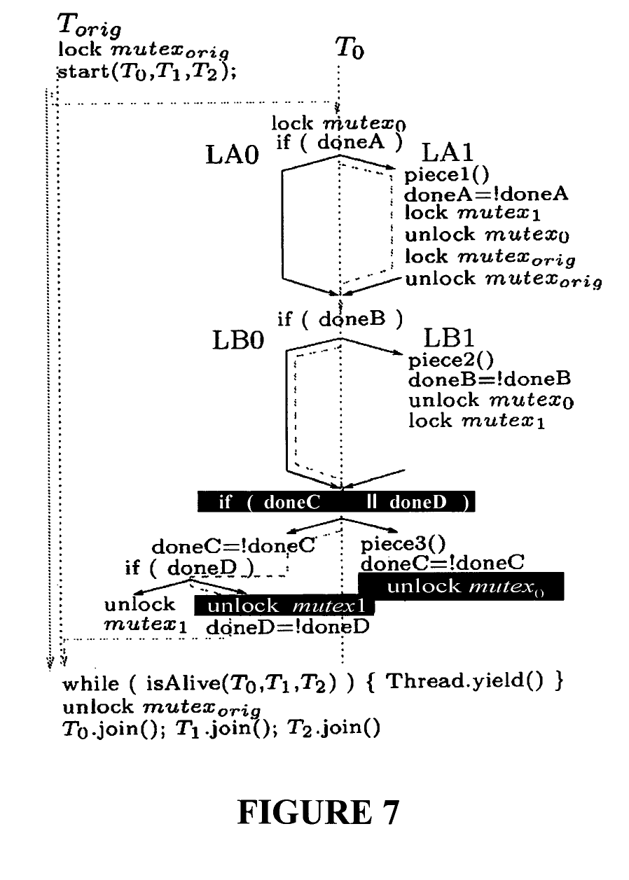

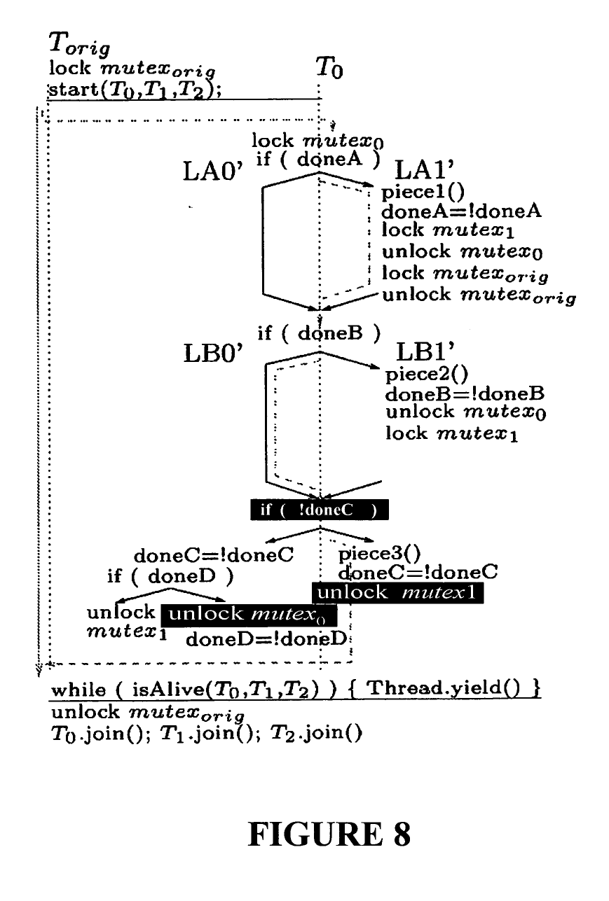

One technique is to divide the selected basic block into three pieces, piece1( ), piece2( ) and piece3( ) with each piece containing zero or more instructions and construct a closure around them. The invention then passes these new closures along with those that implement the watermarks to the new threads for execution as shown in FIGS. 7 and 8.

Referring to FIG. 7, the invention embeds a single watermark bit with value 0. The original thread T_{orig} (the main thread, with ID “1”) locks mutex_{orig} then forks off three new threads T₀, T₁, and T₂ which execute identical closures. The original thread then waits until any one of these threads terminates. The three new threads contend for mutex₀ and the winner proceeds to execute LA1 as shown in FIG. 7. This causes piece1( ) to be executed by the winner while the other threads wait. The body of the threads are identical and because the cases are symmetric, it is assumed that T₀ wins the lock. T₀ proceeds to execute LA1 and lock mutex₁, unlock mutex₀ then blocks waiting for mutex_{orig} which is owned by T_{orig}. Threads T₁ and T₂ now contend for the freed mutex₀ and one of them wins the lock.

Once again, the cases are symmetric and we assume T₁ locks mutex₀. T₁ now executes LB₁ and therefore T₁ executes piece2( ), unlocks mutex₀ and blocks waiting for mutex₁ owned by T₀. At this point, T₀ is still waiting on mutex_{orig}. Finally, T₂ locks mutex₀, executes piece3( ), unlocks mutex₀ and exits. At this point, T_{orig} is able to unlock mutex_{orig} allowing either T₁ or T₂ to wake up, release their locks and exit. Finally, T_{orig} waits until all three threads T₀, T₁ and T₂ have exited before continuing execution. As a result of this execution, three distinct threads have executed the three pieces thereby embedding a bit 0. The behaviour of the program on execution codes for a bit value of 0 in the digital signature bit string.

FIG. 8 illustrates a preferred embedding for a watermark bit of value 1. The behaviour of the threads is identical to embedding a 0 bit, until T₂ evaluates the third conditional marked !done C. In this case, T₂ skips evaluating piece3( ) and instead unlocks mutex₀ and exits. As a result, T_{orig} unlocks mutex_{orig} and T₀ acquires it. T₀ then executes piece3( ) and releases its locks, allowing T₁ to also release its locks and exit. As a result of this execution, the same thread executes piece1( ) and piece3( ) while a different one executes piece2( ). This behaviour is distinguishable from the behaviour of the program code in FIG. 7, where each of the threads execute exactly one of the pieces. This distinguishable sequence of program block executions represents a bit of value 1 in a digital signature bit string.

The introduced code is carefully constructed so that the only differences between the embedding of bit 0 and bit 1 are the arguments to unlock and the third conditional as shown in FIG. 8.

The first of these differences, the arguments to unlock, is obscure to an attacker because in Java monitor_enter and monitor_exit are stack operations. Therefore, it is not possible to statically pattern-match on the code to determine if a 0 or a 1 bit is being embedded, as the behaviour of the computer program is characterised by stack operations. Furthermore, it is difficult given the stack operations to determine purely statically which object mutex₀ or mutex₁ will be on top of the stack when unlock is called.

The second of these differences may allow an attacker to pattern match on the conditional statements to distinguish between an embedding of 0 and an embedding of 1. To prevent this, it is desirable to use opaque predicates to fold the two different expressions into one. An opaque predicate is an expression whose value is known to the person inserting the watermark at the time of watermarking but which is difficult for the attacker to deduce.

An opaque false predicate is an opaque predicate that is always false while an opaque true predicate is one that is always true. To embed bit 0 as shown at 600 in FIG. 6, opaque predicates are introduced at conditional expression 620. One of these predicates is opaquely true, the other two are opaquely false. Alternatively, to embed bit 1 as shown at 610 in FIG. 6, a similar conditional expression 630 is used, but with opaque predicates having the opposite value as in expression 620. Those skilled in the art of Boolean algebra and software obfuscation will understand that there are many equivalent ways to write expressions 620 and 630. For example the opaque predicates may all be of the form “(p==q)” where p and q are pointer variables that may reference the same object.

The opaque predicates can be selected from a large library of opaque predicates that makes pattern matching or static analysis of this expression useless in distinguishing between an embedding of bit 0 or an embedding of bit 1.

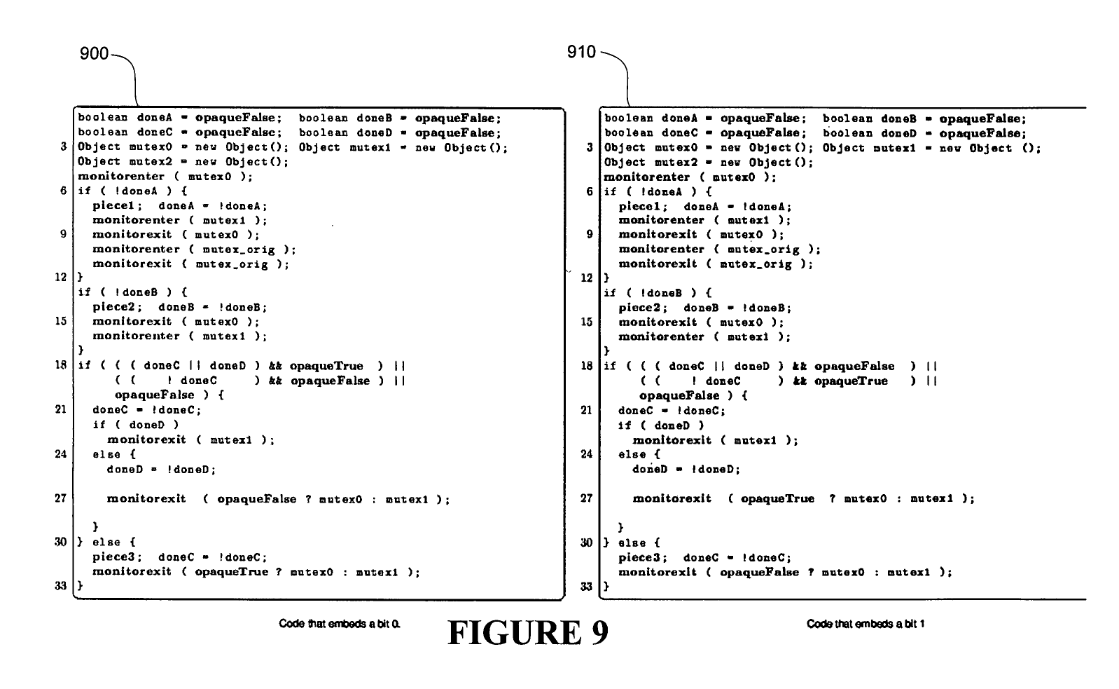

Static differences between an embedding of a bit 0 and a bit 1 may be further reduced by rewriting the watermarking widgets as shown in FIG. 9. Version 900 embeds bit 0, while version 910 embeds bit 1. The only difference between an embedding of 0 and 1 occur in the boolean expressions on line 18, 19, 27, 28 and line 32. However, these predicates are opaque and thus statically indistinguishable. These programs are semantically equivalent to the version given in FIG. 6.

Recognition Process

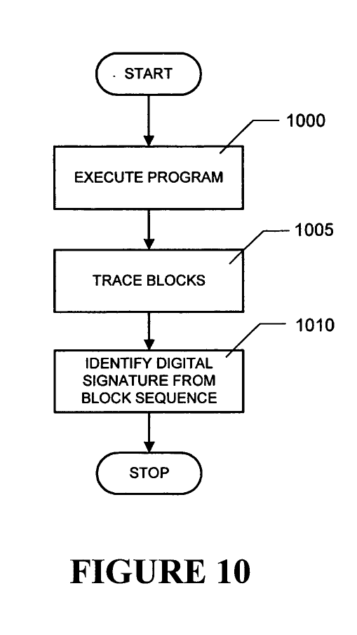

Referring to FIG. 10, the preferred form recognition or detection process of the invention consists of two stages. This involves the recognition or detection of a digital signature or watermark within a software program. The first stage in detecting a digital signature is to execute 1000 the software program with a predefined input I then trace 1005 or record the sequence of basic blocks executed within the software program given the secret input I. In the second stage, the digital signature is then identified 1010 from the recorded sequence of basic blocks executed.

Recognition involves detecting a digital signature within a software program. In particular, watermark recognition involves identifying the original watermark in a possibly tampered piece of program code. As described above, in a scheme using dynamic watermarking, recognition involves replaying or executing the watermarked program with key input and decoding the watermark from the threading behaviour of the application.

Watermarked recognisers can be broadly classified as either detectors or extractors. Detectors are those watermark recognisers that merely report the presence of a watermark, whereas extractors are those that return the encoded value of the watermark.

The invention provides a method of building an extractor and a detector for the watermark of the invention, and methods of extracting and detecting the watermark within a software program. Extraction is a more fundamental method than detection in the present invention. In a preferred embodiment, a watermark detector is built from an extractor. The output of the watermark detector is obtained by comparing the extracted watermark to a known value. Alternatively the output of the detector may be obtained by calculating a mathematical function on the extracted watermark, for example dividing by a constant such as 13 and reporting “watermark detected” only if the remainder is 0.

In order to extract a watermark from a program, the first step is to collect information about the threading behaviour of the watermarked program. Specifically, information is collected about the execution of the program on secret input I, using a technique similar to the tracing technique described above in the watermark-embedding process. The extractor of this invention is only sensitive to the order in which threads acquire locks; from this information the relevant block executions (of piece1( ), piece2( ) and piece3( )) can be deduced during the remainder of the extraction process. Therefore, a list L of lock acquisitions is created, where a thread ID tᵢ is appended to L each time it acquires a lock. Thus L is a list or sequence of thread IDs.

Combinations of three distinct thread IDs are selected from the distinct thread IDs that occur in L, to form a collection S of subsequences sᵢ. Each subsequence sᵢ contains exactly three different thread IDs. If there are four distinct thread IDs in L, then exactly four subsequences are formed. In general, (k)(k−1)(k−2)/6 subsequences are formed from a list L containing k distinct thread IDs.

Each subsequence of length 7n is either a watermark signal or a spurious signal, where n is the length of the watermark signal that was embedded in the program. For the case of the 1-bit embeddings of FIGS. 7 and 8, the value of n is 1 and so the watermark extractor will examine all subsequences sᵢ of length |sᵢ|=7.

For reasons of efficiency, the watermark extractor may construct only the subsequences of length exactly 7, rather than constructing all (k)(k−1)(k−2)/6 subsequences of arbitrary length.

A watermark signal arising from FIG. 7 is a subsequence of the form aabcaab, where a, b, and c are distinct thread IDs. A watermark signal arising from FIG. 8 is a subsequence of the form aabccab. These two signals differ in their fifth symbol, so they can be efficiently and accurately distinguished by the watermark extractor.

It is highly unlikely that any unwatermarked program will have threads with a locking behaviour that exactly matches either aabcaab or aabccab. So the 1-bit watermark extractor is unlikely to produce any spurious outputs. If greater confidence is required in the output of the watermark extractor, or if multiple-bit signatures are desired, then a multiple-bit watermark signal E=<e₁, e₂, . . . , eₙ> must be embedded in the program.

Embedding and Extracting Multi-Bit Watermarks

A simple method for embedding an n-bit watermark signal in a program is to embed n independent 1-bit watermark signals of the form described above. Each of these signals is embedded in a consecutive sequence of three blocks B₁[3i], B₁[3i+1] and B₁[3i+2], executed by thread “1” in trace T. The watermark extractor, when it observes the locking behaviour of the resulting watermarked program, will construct n subsequences sᵢ of length |sᵢ|=7. Each of these subsequences will carry exactly one of the watermark signal bits. The bits can be assembled in the correct order because the lock acquisitions recorded by the extractor in L will appear in the same time-sequenced order as the block executions in reproducible trace T.

Experiments have been performed on three pieces of software, namely TTT, a trivial tic-tac-toe program; JFig, a figure editor, and SciMark, a Java benchmark. This latter benchmark is a composite benchmark consisting of 5 computational kernels used to measure the performance of numerical codes occurring in scientific and engineering applications.

The programs were selected for experimentation because they categorise different types of Java programs that may be watermarked. TTT is a small GUI program of 64 lines with one major loop and all but 4 of the lines in the program are executed on the sample input. JFig is a much larger GUI program of approximately 23,000 lines with most lines of code never being executed. The SciMark benchmark of approximately 13,000 lines is a non-GUI application that consists of many tight loops optimised for numerical computations. A significant number of lines (approximately 5%) are run more than 50,000 times.

The two GUI programs have no bounds on running time and for the purpose of experiment were run for a fixed input. For TTT, this consisted of two games of tic-tac-toe while for JFig was the time taken to draw a simple figure.

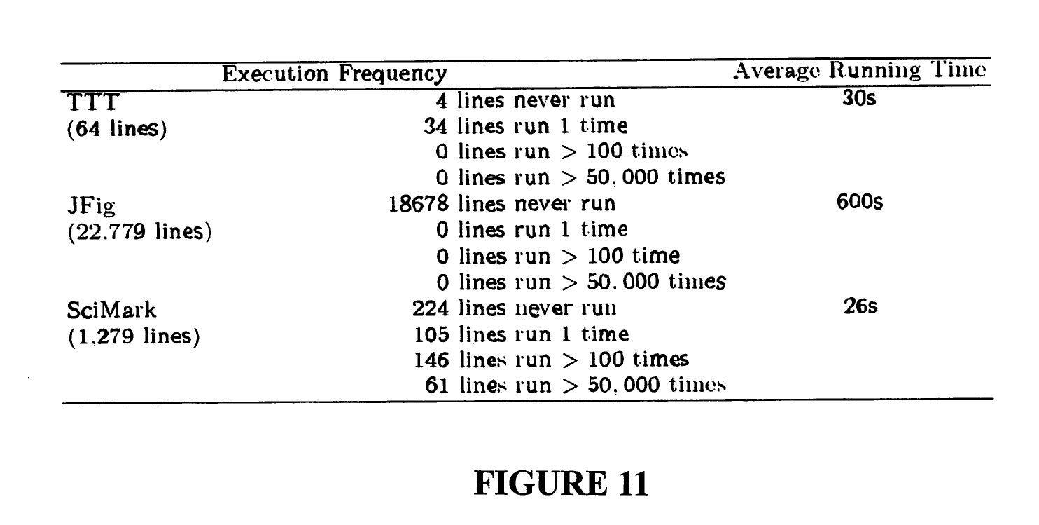

FIG. 11 shows a table summarising the characteristics of these programs. The impact was measured of embedding bits of a watermark on the running time of an application. SciMark performed no IO operations after it was started, therefore it required no special timing harness.

For the two GUI applications, an X event recorder known as xnee was used to record the X events sent to an application. After watermarking the application, the X events were replayed and the entire procedure timed.

The original applications were timed 10 times and averaged to calculate initial speed. Following this, the programs were watermarked and run 10 times again to record any differences in execution speed.

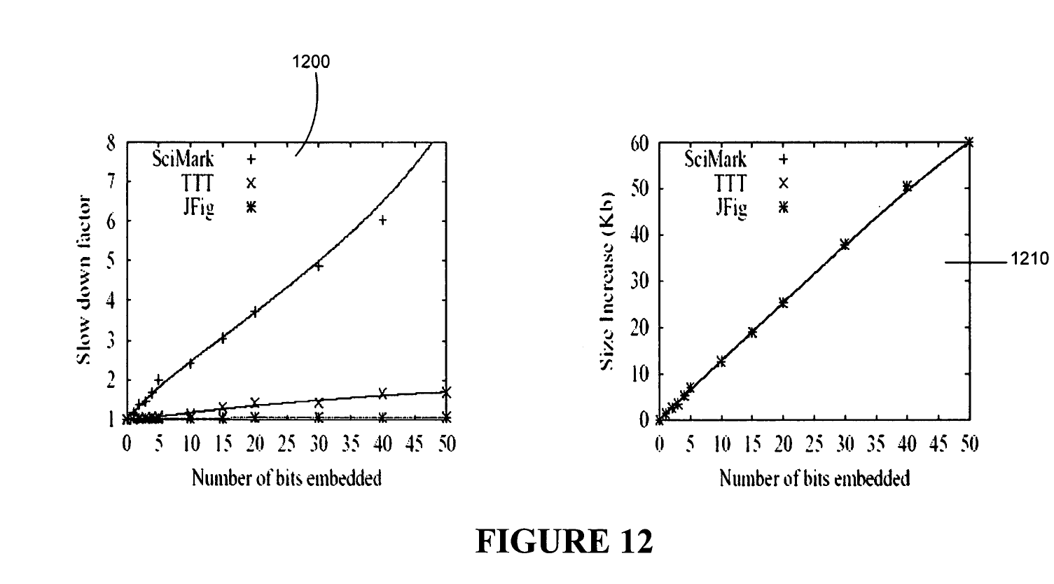

FIG. 12 at 1200 shows the average slowdown resulting from embedding a 48-bit watermark signal. In each of the 10 timed tests, the location at which the watermarks were embedded was selected randomly from the basic block trace that was produced during the trace step.

A point to note is that although inserting a 48 bit watermark signal in SciMark results in a very significant slowdown with a factor of approximately 8, real world applications like TTT and JFig that have a GUI and wait for user interaction were observed to have very few time critical loops. For those applications, the resulting slowdown was much less noticeable.

The size overhead was also measured of embedding thread-based watermarks. The most significant contribution to the increased size of the application was the creation of closures. As shown at 1210, the right hand plot of FIG. 12 shows that thread-based watermarks have a significant impact on the size of the small input application. Each embedding of a watermark bit caused the code size to increase by approximately 1.2 kilobytes.

Attacks and Defences

A software pirate attempting to steal a watermarked program may carry out several different attacks to prevent a watermark from remaining recognisable. To evaluate the resilience of the method of the invention, it is necessary to know how resilient the watermarking scheme is to these attacks.

The simplest static attack that may remove a watermark is obfuscations that rename all variables and methods in a program, reorder blocks of code, or restructure data. A more advanced obfuscation technique that attempts to obscure the identity of variables or methods is “inlining” or “outlining”. Inlining is a common compiler optimisation technique that involves replacing a method call with an instance of the method's body. Similarly, outlining is where a set of instructions is replaced with a call to a method containing those instructions. The method of the invention is resilient to all of these attacks. This is because the recognition relies on the executed behaviour of the program and not on its static structure. This executed behaviour is preserved by these static attacks.

An advanced attack is one where the watermarked program is decompiled then recompiled. Decompilation of programs that contain the watermark of the invention is difficult because although the watermarked code is legal Java byte code, the improperly nested monitor calls means that it cannot be directly expressed in the Java language.

Even if an attacker is given a decompiler able to handle unnested monitors, it is believed that the proposed technique would survive a decompilation attack because the watermark is embedded in the order of execution of threads. This will be maintained by any semantic preserving decompile-recompile transformation. The decompilation attack can be made even more difficult by obfuscating the watermarked program using additional thread switches that are not used for watermark encoding, but which are necessary for program correctness. This can be easily done by introducing straight-line code where one of the two threads executes a subtly different and buggy version of each statement in the original code.

The most potent attack against the method of the invention is one where the attacker succeeds in inserting random thread switches within a watermark piece. Note that it is not enough for the attacker to simply insert new threads, or for the attacker to insert new basic blocks such that an existing thread executes it. These types of errors are successfully corrected during the decoding process of the invention.

For an attacker to successfully prevent the extractor from recognizing the watermark, the attacker must insert or remove “lock” calls on some mutex. Removal of “lock” calls is very dangerous and difficult; if done without a deep understanding of the underlying program it is very likely to result in a program with unreliable (sometimes incorrect) behaviour. However a lock-addition attack can be achieved simply by adding code that declares a mutex, locks this mutex, and (to avoid possible deadlock), unlocks this mutex immediately after it was locked. Such attacks could be defeated by suitable modification of the extractor: it can record mutexIDs as well as threadIDs in list L.

Executions of the code in FIGS. 7 and 8 always result in the following sequence of mutex locks obtained by threads T₀, T₁, and T₂: mutex₀, mutex₁, mutex₀, mutex₀, mutex_{orig}, mutex₀, mutex₁. This sequence is always preceded by thread T_{orig} gaining a lock on mutex_{orig}. Any additional mutexes introduced by an attacker will be easily distinguishable from the originally-embedded sequence of locks, unless the attacker introduces additional “lock” calls on mutex_{orig}, mutex₀, or mutex₁. Such re-uses of an existing lock are extremely hazardous to program correctness, so the invention has a strong level of defence against an attacker who changes the locking behaviour of the watermarked program.

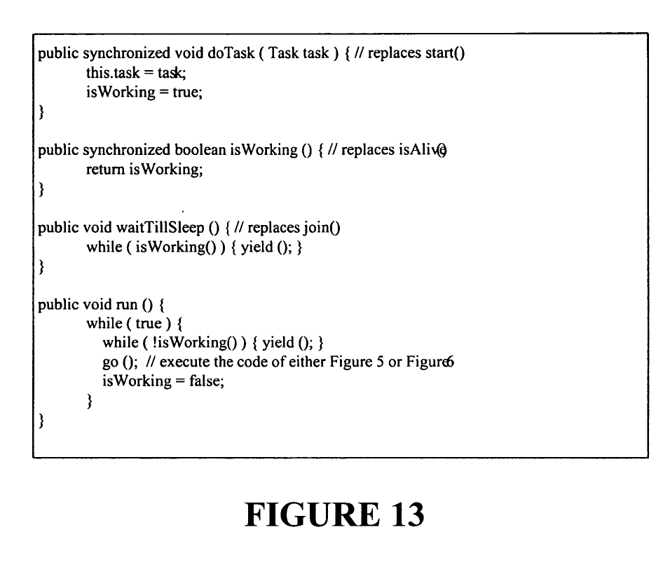

In FIG. 13 is shown an alternative technique for embedding n-bit watermark signals, where new threads are not created for each watermark bit. The first three methods in FIG. 13 are (respectively) substitutes for the “start”, “isAlive” and “join” calls by thread T_{orig} in FIGS. 7 and 8. The fourth method, named “run”, is executed by watermarking threads T₀, T₁, and T₂. Each of these threads has an additional Boolean variable named isworking which it uses for communicating status information with the main thread T_{orig}. All watermarking threads busy-wait in the first while-loop of their run( ) routine until T_{orig} calls a doTask( ) method which sets its thread's isworking flag to true. By calling a watermarking thread's isworking( ) method, the main thread T_{orig} can determine if any watermarking thread has completed its go( ) routine. The main thread can also determine if all watermarking threads have completed their go( ) routines, with a busy-wait in a waitTillSleep( ) method.

Using the technique of FIG. 13, any number n of watermark signal bits can be embedded in the locking behaviour of three threads. This technique will allow more efficient execution of watermark programs, because of the reduced number of threads, especially if the code in FIG. 13 is modified to use mutex “lock” statements instead of busy-waiting “while” loops. This technique will also allow more efficient and reliable watermark extraction, because the lock sequence L will have fewer distinct threadIDs, and because the subsequence sᵢ encoding the n-bit watermark can be more efficiently and effectively filtered to remove any spurious lock-insertions by an attacker.

The invention provides a novel technique for embedding watermarks using multiple threads, locks and thread contention. In particular, the invention provides a method of encoding the watermark in preparation for embedding, a method of embedding a single bit and multi-bit watermark, and methods of recognising the watermark.

Experimental results using an implementation to watermark Java byte code indicate that the cost of watermarking is relatively small for real world applications. In addition, the effectiveness of several classes of attacks against thread-based watermarks can be eliminated or at least minimised.

The foregoing describes the invention including preferred forms thereof. Alterations and modifications as will be obvious to those skilled in the art are intended to be incorporated within the scope hereof, as defined by the accompanying claims.

1. A method of introducing a digital signature into a software program, the software having a plurality of basic blocks, the method comprising the steps of:
executing the software program;
recording the sequence(s) of basic blocks executed within the software program;
modifying the software program to increase the number of threads, thereby increasing the number of possible sequences of basic blocks executed within the software program; and
associating the sequence of basic blocks executed by one or more threads with a digital signature.

2. A method of introducing a digital signature into a software program as claimed in claim 1 wherein two or more of the plurality of basic blocks have associated respective block identifiers.

3. A method of introducing a digital signature into a software program as claimed in claim 2 wherein the recorded sequence(s) of basic blocks executed is/are expressed as a sequence of block identifiers representing the sequence of basic blocks executed.

4. A method of introducing a digital signature into a software program as claimed in claim 3 wherein at least one of the recorded sequences has an associated sequence identifier.

5. A method of introducing a digital signature into a software program as claimed in claim 1 wherein the data input is selected such that the same recorded sequence is reproducible on multiple executions of the software program.

6. A method of introducing a digital signature into a software program as claimed in claim 1 wherein the step of modifying the software program includes the step of inserting one or more locks so that one or more basic blocks are able to control subsequent basic blocks executed.

7. A method of introducing a digital signature into a software program as claimed in claim 6 wherein the behaviour of the computer program on execution represents the value of at least one bit in a digital signature bit string representing the digital signature.

8. A method of introducing a digital signature into a software program as claimed in claim 7 wherein the behaviour of the computer program is resistant to pattern matching techniques.

9. A method of introducing a digital signature into a software program as claimed in claim 7 wherein the selection of locks is effected by stack operations.

10. A method of introducing a digital signature into a software program as claimed in claim 7 wherein the selection of locks is effected by opaque predicates.

11. A method of introducing a digital signature into a software program as claimed in claim 1 wherein the software program includes a plurality of conditional statements, the method further comprising the step of introducing an opaque predicate into at least one of the conditional statements.

12. A method of introducing a digital signature into a software program as claimed in claim 1 wherein the step of modifying the software program includes the step of increasing the number of basic blocks in the software program.

13. A method of introducing a digital signature into a software program as claimed in claim 12 wherein the step of increasing the number of basic blocks includes the step of subdividing one or more basic blocks.

14. A method of introducing a digital signature into a software program as claimed in claim 12 wherein the step of increasing the number of basic blocks includes the step of adding one or more redundant basic blocks.

15. A method of introducing a digital signature into a software program as claimed in claim 1 in which the software program is configured to accept a data input, wherein the software program is executed given the data input and the sequence(s) of basic blocks executed within the software program given the data input is recorded.

16. A method of extracting a digital signature from a software program, the software having a plurality of basic blocks and a plurality of threads, and configured to accept data input, the method comprising the steps of:
executing the software program with a predefined data input;
recording the sequence(s) of basic blocks executed within the software program given the data input; and
identifying the digital signature from the recorded sequences of basic blocks executed by one or more threads.

17. A method of extracting a digital signature from a software program as claimed in claim 16 in which the software program includes one or more locks so that one or more basic blocks are able to control subsequent basic blocks executed, wherein the step of recording the sequence(s) of basic blocks executed further comprises the steps of:
identifying a lock acquisition occurrence; and
adding to a list of lock acquisitions, an identifier representing the sequence that has caused the lock acquisition.

18. A method of extracting a digital signature from a software program as claimed in claim 17 further comprising the steps of:
selecting at least one combination of distinct lock acquisitions from the list, to form one or more subsequences; and
identifying the digital signature from one of the subsequences.

19. A system for introducing a digital signature into a software program, the software having a plurality of basic blocks, where the system is configured to:
execute the software program;
record the sequence(s) of basic blocks executed within the software program;
modify the software program to increase the number of threads, thereby increasing the number of possible sequences of basic blocks executed within the software program; and
associate the sequence of basic blocks executed by one or more threads with a digital signature.

20. A system for extracting a digital signature from a software program, the software having a plurality of basic blocks and a plurality of threads, and configured to accept data input, where the system is configured to:
execute the software program with a predefined data input;
record the sequence(s) of basic blocks executed within the software program given the data input; and
identify the digital signature from the recorded sequences of basic blocks executed by one or more threads.

21. A computer program stored on tangible storage media comprising executable instructions for introducing a digital signature into a software program, the software having a plurality of basic blocks, the method comprising the steps of;
recording the sequence(s) of basic blocks executed within the software program;
modifying the software program to increase the number of threads, thereby increasing the number of possible sequences of basic blocks executed within the software program; and
associating the sequence of basic blocks executed by one or more threads with a digital signature.

22. A computer program stored on tangible storage media comprising executable instructions for extracting a digital signature from a software program, the software having a plurality of basic blocks and a plurality of threads, and configured to accept data input, the method comprising the steps of:
executing the software program with a predefined data input;
recording the sequence(s) of basic blocks executed within the software program given the data input; and
identifying the digital signature from the recorded sequences of basic blocks executed by one or more threads.
